(19) United States
(12) Patent Application Publication
(10) Pub. No.: US 2014/0353557 A1
(43) Pub. Date: Dec. 4, 2014

(54) Photosensitive Resin Composition, Black Spacer Prepared by Using the Composition, and Color Filter Having the Black Spacer

(71) Applicant: Cheil Industries Inc., Gumi-si (KR)

(72) Inventors: Arum YU, Uiwang-si (KR); Ji-Hye KIM, Uiwang-si (KR); Kyung-Won AHN, Uiwang-si (KR); Jae-Bum YIM, Uiwang-si (KR); Hwan-Sung CHEON, Uiwang-si (KR); Hyun-Moo CHOI, Uiwang-si (KR)

(73) Assignee: Cheil Industries Inc., Gumi-si (KR)

(21) Appl. No.: 14/248,795

(22) Filed: Apr. 9, 2014

(30) Foreign Application Priority Data
May 31, 2013 (KR) 10-2013-0062976

(51) Int. Cl. G02B 5/23

(52) U.S. Cl. CPC G02B 5/23
USPC 252/586

(57) ABSTRACT

A photosensitive resin composition includes (A) a colorant including an organic black pigment or an organic mixed pigment capable of showing black; (B) a binder resin; (C) a photopolymerizable compound; (D) a photopolymerization initiator; (E) an inorganic filler; and (F) a solvent. The composition has an O.D. of greater than or equal to about 2.0 after being coated on a substrate to a thickness of about 4 μm and being cured, and a transmittance of greater than or equal to about 12% in a 950 nm wavelength region. A black spacer includes the photosensitive resin composition.

### CROSS-REFERENCE TO RELATED APPLICATION

This application claims priority to and the benefit of Korean Patent Application No. 10-2013-0062976 filed in the Korean Intellectual Property Office on May 31, 2013, the entire disclosure of which is incorporated herein by reference.

### FIELD OF THE INVENTION

This disclosure relates to a photosensitive resin composition, a black spacer prepared using the same, and a color filter including the black spacer.

### BACKGROUND OF THE INVENTION

A photosensitive resin composition is a material necessarily used to manufacture a display device such as a color filter, a liquid crystal display material, an organic light emitting diode (EL), a display panel material, and the like. For example, a color filter of a color liquid crystal display and the like requires a light-blocking layer on the boundary of color layers such as red, green, blue, and the like to increase display contrast or a chromophore effect. This light-blocking layer is mainly formed of a photosensitive resin composition.

Recently, there have been attempts to use such a light-blocking layer material as a black spacer (black photo-spacer) supported between two TFT and C/F substrates interposed by liquid crystal layers. A black spacer requires chemical resistance to a solvent for polyimide, an upper layer of the black spacer, and to a solution for rework. A black spacer also should exhibit a step difference by adjusting an exposure dose with a half tone mask. In addition, a black spacer should exhibit basic characteristics such as compression displacement, an elasticity recovery rate, breaking strength, and the like.

### SUMMARY OF THE INVENTION

One embodiment of the present invention provides a photosensitive resin composition that can have excellent heat resistance, chemical resistance, and/or reliability.

Another embodiment of the present invention provides a black spacer manufactured using the photosensitive resin composition.

Yet another embodiment of the present invention provides a color filter including the black spacer manufactured using the photosensitive resin composition.

In one embodiment of the present invention, a photosensitive resin composition has an optical depth (O.D.) and transmittance within predetermined ranges when coated on a substrate and cured in a predetermined thickness.

Specifically, the composition is a black photosensitive resin composition including (A) a colorant including an organic black pigment or an organic mixed pigment capable of showing black; (B) a binder resin; (C) a photopolymerizable compound; (D) a photopolymerization initiator; (E) an inorganic filler; and (F) a solvent, wherein the composition has an O.D. of greater than or equal to about 2.0 after being coated on a substrate to a thickness of about 4 μm and being cured, and a transmittance of greater than or equal to about 12% in a 950 nm wavelength region.

The colorant of the photosensitive resin composition may further include an inorganic black pigment.

When the composition further includes an inorganic black pigment, the inorganic black pigment may be included in an amount of about 10 to about 50 wt % based on the total weight of the organic black pigment or organic mixed pigment capable of showing black.

The organic black pigment or organic mixed pigment capable of showing black and the inorganic black pigment may be included in an amount of about 1 to about 20 wt %, for example about 2 to about 10 wt %, based on the total weight of the photosensitive resin composition.

The organic black pigment may include perylene black, cyanine black, or lactam-based organic black, and may be used singularly or in a mixture of two or more.

The organic black pigment may be represented by the following Chemical Formula 1:

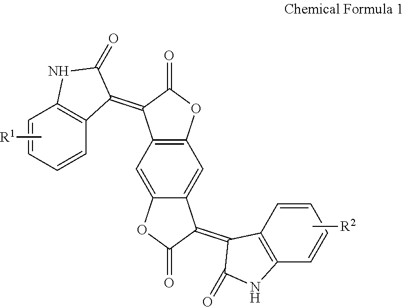

In Chemical Formula 1, R¹ and R² are the same or different and are each independently hydrogen, halogen, or substituted or unsubstituted C1 to C20 alkyl.

The organic mixed pigment capable of showing black may be any pigment to show black by combining at least two kinds of pigments selected from a red-based pigment, a blue-based pigment, a green-based pigment, a violet-based pigment, a yellow-based pigment, a cyanine-based pigment, and a magenta-based pigment.

The inorganic black pigment may include carbon black, chromium oxide, iron oxide, titan black, titanium carbide, aniline black, or a combination thereof.

The binder resin (B) may be a cardo-based resin, or a mixture of a cardo-based resin and an acrylic-based resin.

The binder resin (B) may be included in an amount of about 2 to about 20 wt % based on the total weight of the photosensitive resin composition.

The inorganic filler (E) may be silica.

The silica may be fumed silica, fused silica, particulate silica, and the like.

The inorganic filler (E) may be included in an amount of about 0.05 to about 5 wt % based on the total weight of the photosensitive resin composition.

The photosensitive resin composition may include about 1 to about 20 wt % of (A) the colorant including an organic black pigment or an organic mixed pigment capable of showing black; about 2 to about 20 wt % of (B) the binder resin; about 1 to about 20 wt % of (C) the photopolymerizable compound; about 0.05 to about 5.0 wt % of (D) the photopolymerization initiator; about 0.05 to about 5 wt % of (E) the inorganic filler; and a balance amount of (F) the solvent.

Another embodiment of the present invention provides a black spacer manufactured using the photosensitive resin composition is provided.

Yet another embodiment of the present invention provides a color filter including the black spacer.

Other embodiments of the present invention are included in the following detailed description.

The photosensitive resin composition can have excellent heat resistance, chemical resistance, and/or reliability and thus can provide a black spacer having improved forming capability of a film step difference and storage properties.

### BRIEF DESCRIPTION OF THE DRAWINGS

FIG. 1 includes scanning electron microscope (SEM) photographs showing tapering measurements after post-baking the compositions of Example 1 and Comparative Examples 1 to 3.

FIG. 2 includes photographs showing elution evaluation results of black spacers of the compositions of Example 1 and Comparative Examples 1 to 3.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” refers to one substituted with a substituent including a halogen atom (F, Cl, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C30 heteroaryl group, or a combination thereof, instead of at least one hydrogen.

As used herein, when a specific definition is not otherwise provided, the term “hetero” may refer to one substituted with at least one hetero atom including N, O, S and/or P, instead of at least one C in a cyclic substituent.

As used herein, when a specific definition is not otherwise provided, “(meth)acrylate” refers to both “acrylate” and “methacrylate”, and “(meth)acrylic acid” refers to “acrylic acid” and “methacrylic acid”.

A photosensitive resin composition according to one embodiment is a black photosensitive resin composition including (A) a colorant including an organic black pigment and/or an organic mixed pigment capable of showing black (that is, a mixture of organic pigments that when combined show black); (B) a binder resin; (C) a photopolymerizable compound; (D) a photopolymerization initiator; (E) an inorganic filler; and (F) a solvent, wherein the composition has an O.D. (optical depth) of greater than or equal to about 2.0, after being coated on a substrate to a thickness of about 4 μm and being cured, and a transmittance of greater than or equal to about 12% in a 950 nm wavelength region.

The photosensitive resin composition is a black photosensitive resin composition, which can be used for the manufacture of a black spacer.

The black spacer has a combined structure of a light-blocking layer and a column spacer, and may be manufactured through one pattern-forming process. A black spacer is required to have an optical density (O.D.) and simultaneously to recognize an align key of a panel substrate after patterning of a black spacer, and therefore is required to have transmittance of greater than or equal to about 12% in a 950 nm wavelength region. Therefore, an organic black pigment or an organic mixed pigment capable of showing black should be used for the manufacture of a black spacer. In the case of an organic black pigment or organic mixed pigment capable of showing black, however, a metal ion and a pigment of a spacer pattern may be easily eluted by a solvent as compared with an inorganic pigment such as carbon black. Accordingly, using a minimum amount of an organic pigment can help reliability properties at spacer development. Nevertheless, in order to satisfy the required O.D., an organic pigment may be used in an amount of more than the required amount. For example, the step difference of a film thickness and a film residual rate that are realized immediately after exposure and development may decrease or a taper of a pattern may decrease, because high temperature properties of a composition become weak and a pattern collapses after a post-bake (about 220° C., for 20 to 30 minutes) process. Because a post-bake temperature (about 220° C.) is remarkably high, high temperature flow characteristics of a pattern at the temperature may be more affected by an amount of a pigment (PWC, pigment weight percent) rather than Tg (glass transition temperature) or a molecular weight (Mw) of a resin. Therefore, in order to increase a taper, when an amount of an organic black pigment increases, various reliability properties of black spacer such as elution resistance, ion elution, VHR (Voltage Holding Ratio) may be deteriorated or below the desired level.

Therefore, in one embodiment of the present invention, provided is a black photosensitive resin composition that can have transmittance and O.D. (Optical depth) above the predetermined range required for a black spacer in a predetermined wavelength range, and can have improved heat resistance, chemical resistance, and/or reliability, which may be achieved by a photosensitive resin composition including an organic black pigment or organic mixed pigment capable of showing black and an inorganic filler as in the above embodiment.

Hereinafter, each component of the resin composition is described in detail.

(A) Colorant

The photosensitive resin composition includes an organic black pigment or an organic mixed pigment capable of showing black (that is, a mixture of organic pigments that when combined shows black) as a colorant (A).

The organic black pigment or the organic mixed pigment capable of showing black may further include an inorganic pigment. The organic black pigment or the organic mixed pigment capable of showing black may include the inorganic pigment in an amount of about 10 to about 50 wt %, based on the total weight (100 wt %) of the organic black pigment or organic mixed pigment capable of showing black. In some embodiments, the organic black pigment or organic mixed pigment capable of showing black may include the inorganic pigment in an amount of about 10, 11, 12, 13, 14, 15, 16, 17, 18, 19, 20, 21, 22, 23, 24, 25, 26, 27, 28, 29, 30, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the inorganic pigment can be in a range from about any of the foregoing amounts to about any other of the foregoing amounts.

When the organic black pigment or organic mixed pigment capable of showing black is mixed with the inorganic pigment, high optical density may be realized.

The organic black pigment or organic mixed pigment capable of showing black can have insulation properties.

Examples of the organic black pigment may include without limitation perylene black, cyanine black, and/or lactam-based organic black, which may be used singularly or in a mixture of two or more. In an exemplary embodiment, the lactam-based organic black pigment is used. The lactam-based organic black pigment can have the following chemical Formula 1:

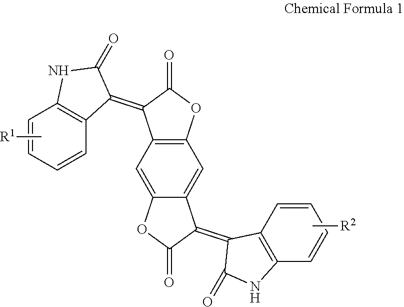

In Chemical Formula 1, R¹ and R² are the same or different and are each independently hydrogen, halogen, or substituted or unsubstituted C1 to C20 alkyl.

The organic black pigment may be a mixture of two or more kinds of organic pigments to show black, that is to say, an organic mixed pigment capable of showing black. The organic black pigment may be any combination of pigments that may show black in a color coordinate, for example blackening combinations of at least two pigments including a red-based pigment, a blue-based pigment, a green-based pigment, a violet-based pigment, a yellow-based pigment, a cyanine-based pigment, and/or a magenta-based pigment. For example, a mixture of a red-based pigment, a blue-based pigment, and a green-based pigment to show black, and a mixture of a green-based pigment and a violet-based pigment to show black may be used.

Examples of the red-based pigment may include without limitation perylene-based pigments, anthraquinone-based pigments, dianthraquinone-based pigments, azo-based pigments, diazo-based pigments, quinacridone-based pigments, anthracene-based pigments, and the like, and combinations thereof. Specific examples of the red-based pigment may include without limitation perylene pigments, quinacridone pigments, naphthol AS, sicomin pigments, anthraquinones (sudan I, II, III, R), dianthraquinonylates, bis azos, benzopyranes, and the like, and combinations thereof.

Examples of the blue-based pigment may include without limitation metal phthalocyanine-based pigments, indanthrone-based pigments, indophenol-based pigments, and the like, and combinations thereof. Specific examples of the blue-based pigment may include without limitation phthalocyanine metal complexes such as copper phthalocyanine, chloro copper phthalocyanine, chloro aluminum phthalocyanine, titanyl phthalocyanine, vanadic acid phthalocyanine, magnesium phthalocyanine, zinc phthalocyanine, iron phthalocyanine, cobalt phthalocyanine, and the like, and combinations thereof.

Examples of the green-based pigment may include without limitation halogenated phthalocyanine-based pigments, and the like, and combinations thereof. Specific examples of the green-based pigment may include without limitation polychloro copper phthalocyanine, polychloro bromo phthalocyanine, and the like, and combinations thereof.

Examples of the violet-based pigment may include without limitation dioxazine violet, first violet B, methyl violet, indanthrene brilliant violet, and the like, and combinations thereof.

Examples of the yellow-based pigment may include without limitation tetrachloro isoindolinone-based pigments, hansa-based pigments, benzidine yellow-based pigments, azo-based pigments, and the like, and combinations thereof. Specific examples of the yellow-based pigment may include without limitation hansa yellows (10G, 5G, 3G, G, GR, A, RN, R), benzidines (G, GR), chrome yellow, permanent yellows (FGL, H10G, HR), anthracenes, and the like, and combinations thereof.

Examples of the cyanine-based pigment may include without limitation non-metal phthalocyanines, merocyanines, and the like, and combinations thereof.

Examples of the magenta-based pigment may include without limitation dimethyl quinacridone, thio indigo, and the like.

Examples of the inorganic pigment may include without limitation carbon black, chromium oxide, iron oxide, titan black, titanium carbide, aniline black, and the like. Such an inorganic pigment can have high resistance characteristics, and may be used singularly or in a mixture of two or more kinds.

The photosensitive resin composition may include a total amount of the colorant including the organic pigment or the black pigment and the inorganic pigment of about 1 to about 20 wt %, for example about 2 to about 10 wt %, based on the total weight (100 wt %) of the photosensitive resin composition. In some embodiments, the photosensitive resin composition may include colorant in a total amount of about 1, 2, 3, 4, 5, 6, 7, 8, 9, 10, 11, 12, 13, 14, 15, 16, 17, 18, 19, or 20 wt %. Further, according to some embodiments of the present invention, the total amount of colorant can be in a range from about any of the foregoing amounts to about any other of the foregoing amounts.

When the photosensitive resin composition includes the colorant in a total amount within the above ranges, the manufactured black spacer may have a transmittance of greater than or equal to about 12% in a 950 nm wavelength region and an O.D. above a predetermined range when being coated to a thickness of about 4 μm.

The photosensitive resin composition may further include a dispersing agent in order to improve dispersion of the pigment. Specifically, the pigment may be surface-pretreated with a dispersing agent, or the pigment and dispersing agent may be added together during preparation of the photosensitive resin composition.

(B) Binder Resin

The binder resin may endow the photosensitive resin composition with close-contacting (adhesive) force, developability, and the like.

The binder resin may include a cardo-based resin, or a mixture of a cardo-based resin and an acrylic-based resin. When the cardo-based resin or a mixture of a cardo-based resin and an acrylic-based resin is used, heat resistance, chemical resistance, and/or close contacting properties of the photosensitive resin composition may be improved.

The cardo-based resin may be a compound including a repeating unit represented by the following Chemical Formula 2:

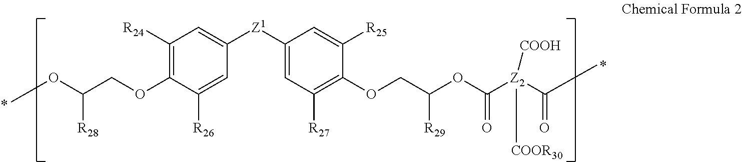

In the above Chemical Formula 2,

R₂₄ to R₂₇ are the same or different and are each independently hydrogen, halogen, or substituted or unsubstituted C1 to C20 alkyl,

R₂₈ and R₂₉ are the same or different and are each independently hydrogen or —CH₂ORₐ (wherein Rₐ is a vinyl group, an acrylate group or a methacrylate group),

each R₃₀ is the same or different and each is independently hydrogen, substituted or unsubstituted C1 to C20 alkyl, substituted or unsubstituted C2 to C20 alkenyl, acrylate group or methacrylate group,

each Z₁ is the same or different and each is independently a single bond, —O—, —CO—, —SO₂—, —CR_{b}R_{c}—, —SiR_{d}Rₑ— (wherein R_{b} to Rₑ are the same or different and are each independently hydrogen or substituted or unsubstituted C1 to C20 alkyl), or a linking group selected from the following Chemical Formulae 3 to 13, and

each Z₂ is the same or different and each is independently an acid dianhydride residual group.

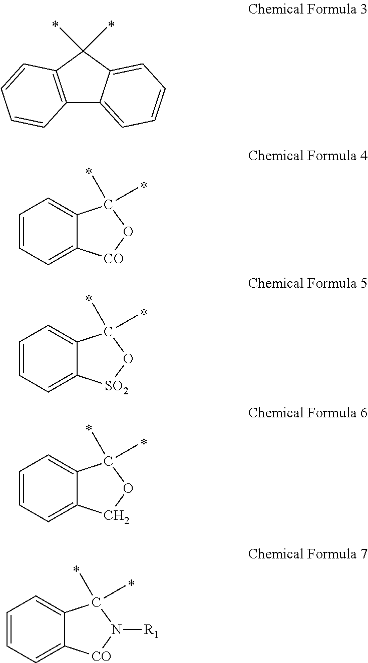

In the above Chemical Formula 7,

R_{f} is hydrogen, ethyl, —C₂H₄Cl, —C₂H₄OH, —CH₂CH═CH₂, or phenyl.

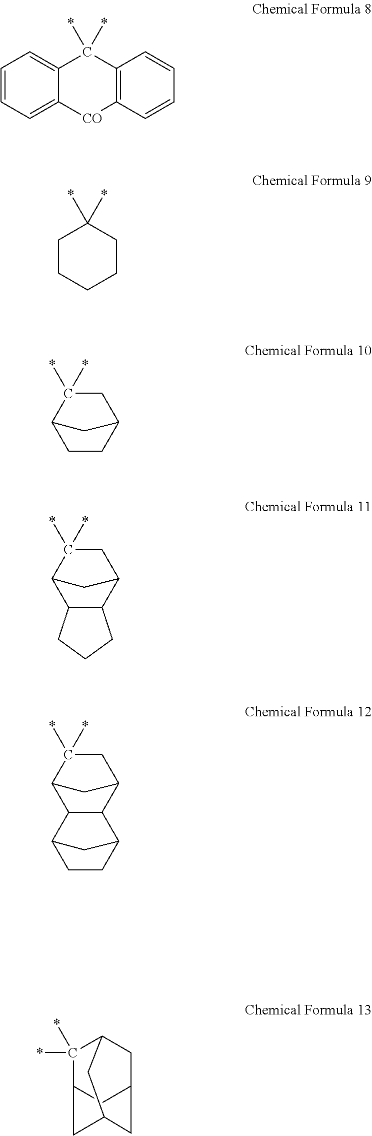 [SMILES: *C1(*)c2ccccc2C(=O)c2ccccc21 ; *C1(*)CCCCC1 ; *C1(*)CC2CCC1C2 ; *C1(*)CC2CC1C1CCCC21 ; *C1(*)CC2CC1C1C3CCC(C3)C21 ; *C1(*)C2CC3CC(C2)CC1C3]

The cardo-based resin may be obtained by reacting a compound represented by the following Chemical Formula 14 and tetracarboxylic acid dianhydride.

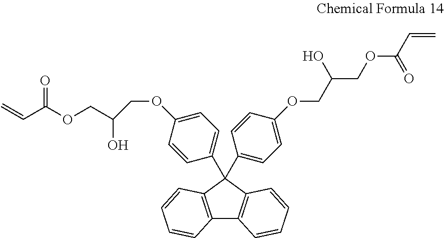 [SMILES: C=CC(=O)OCC(O)COc1ccc(C2(c3ccc(OCC(O)COC(=O)C=C)cc3)c3ccccc3-c3ccccc32)cc1]

The tetracarboxylic acid dianhydride may be an aromatic tetracarboxylic acid dianhydride. Examples of the aromatic tetracarboxylic acid dianhydride may include without limitation pyromellitic acid dianhydride, 3,3′,4,4′-biphenyltetracarboxylic acid dianhydride, 2,3,3′,4-biphenyltetracarboxylic acid dianhydride, 2,2′,3,3′-biphenyltetracarboxylic acid dianhydride, 3,3′,4,4′-benzophenonetetracarboxylic acid dianhydride, 3,3′,4,4′-biphenylethertetracarboxylic acid dianhydride, 3,3′,4,4′-diphenylsulfonetetracarboxylic acid dianhydride, 1,2,3,4-cyclopentanetetracarboxylic acid dianhydride, 1,2,5,6-naphthalenetetracarboxylic acid dianhydride, 2,3,6,7-naphthalenetetracarboxylic acid dianhydride, 1,4,5,8-naphthalenetetracarboxylic acid dianhydride, 2,3,5,6-pyridinetetracarboxylic acid dianhydride, 3,4,9,10-perylenetetracarboxylic acid dianhydride, 2,2-bis(3,4-dicarboxylphenyl)hexafluoropropane dianhydride, and the like, and combinations thereof.

The cardo-based resin may have a weight average molecular weight of about 1,000 to about 20,000 g/mol, for example about 3,000 to about 10,000 g/mol. When the cardo-based resin has a weight average molecular weight within the above range, excellent patterning properties and/or developability may be obtained during manufacture of a light-blocking layer, a column spacer, and/or a black spacer.

The acrylic-based resin is a copolymer of a first ethylenic unsaturated monomer and a second ethylenic unsaturated monomer that is copolymerizable with the first ethylenic unsaturated monomer and includes at least one acrylic-based repeating unit.

The first ethylenic unsaturated monomer is an ethylenic unsaturated monomer including at least one carboxyl group. Examples of the first ethylenic unsaturated monomer include without limitation acrylic acid, methacrylic acid, maleic acid, itaconic acid, fumaric acid, and the like, and combinations thereof.

The acrylic-based resin may include the first ethylenic unsaturated monomer in an amount ranging from about 5 to about 50 wt %, for example, from about 10 to about 40 wt %, based on the total weight (100 wt %) of the acrylic-based resin.

Examples of the second ethylenic unsaturated monomer may include without limitation aromatic vinyl compounds such as styrene, α-methylstyrene, vinyltoluene, vinylbenzylmethylether, and the like; unsaturated carboxylic acid ester compounds such as methyl(meth)acrylate, ethyl(meth)acrylate, butyl(meth)acrylate, 2-hydroxyethyl(meth)acrylate, 2-hydroxy butyl(meth)acrylate, benzyl(meth)acrylate, cyclohexyl(meth)acrylate, phenyl(meth)acrylate, and the like; unsaturated carboxylic acid amino alkyl ester compounds such as 2-aminoethyl(meth)acrylate, 2-dimethylaminoethyl(meth)acrylate, and the like; carboxylic acid vinyl ester compounds such as vinyl acetate, vinyl benzoate, and the like; unsaturated carboxylic acid glycidyl ester compounds such as glycidyl(meth)acrylate and the like; vinyl cyanide compounds such as (meth)acrylonitrile and the like; unsaturated amide compounds such as (meth)acrylamide and the like; and the like. They may be used singularly or as a mixture of two or more.

Examples of the acrylic-based resin may include without limitation a methacrylic acid/benzylmethacrylate copolymer, a methacrylic acid/benzylmethacrylate/styrene copolymer, a methacrylic acid/benzylmethacrylate/2-hydroxyethylmethacrylate copolymer, a methacrylic acid/benzylmethacrylate/styrene/2-hydroxyethylmethacrylate copolymer, and the like, but are not limited thereto. They may be used singularly or as a mixture of two or more.

The acrylic-based resin may have a weight average molecular weight ranging from about 3,000 to about 150,000 g/mol, for example, about 5,000 to about 50,000 g/mol, and as another example about 7,000 to about 30,000 g/mol. When the acrylic-based resin has a weight average molecular weight within the above range, the photosensitive resin composition can have good physical and/or chemical properties, appropriate viscosity, and/or close-contacting (adhesive) properties with a substrate during manufactures of a light-blocking layer, a column spacer, and/or a black spacer.

The acrylic-based resin may have an acid value ranging from about 15 to about 150 mgKOH/g, for example about 80 to about 130 mgKOH/g. When acrylic-based resin has an acid value within the above range, excellent resolution of a pixel pattern may be realized.

The binder resin may have a weight average molecular weight of about 1,000 to about 50,000 g/mol.

The photosensitive resin composition may include the binder resin in an amount of about 2 to about 20 wt %, for example about 5 to about 10 wt %, based on the total weight (100 wt %) of the photosensitive resin composition. In some embodiments, the photosensitive resin composition may include the binder resin in an amount of about 2, 3, 4, 5, 6, 7, 8, 9, 10, 11, 12, 13, 14, 15, 16, 17, 18, 19, or 20 wt %. Further, according to some embodiments of the present invention, the amount of binder resin can be in a range from about any of the foregoing amounts to about any other of the foregoing amounts.

When photosensitive resin composition includes the binder resin in an amount within the above range, a viscosity may be maintained appropriately and excellent pattern, processibility, and/or developability may be obtained during manufacture of a light-blocking layer, a column spacer, and/or a black spacer.

(C) Photopolymerizable Compound

The photopolymerizable compound is a compound to be photopolymerized by the above-described photopolymerization initiator.

The photopolymerizable compound may be a monofunctional and/or multi-functional ester of (meth)acrylic acid having at least one ethylenic unsaturated double bond.

The photopolymerizable compound causes sufficient polymerization at exposure during pattern forming processes to form patterns that can have excellent heat resistance, light resistance, and/or chemical resistance, due to the ethylenic unsaturated double bond.

Examples of the photopolymerizable compound may include without limitation ethylene glycol di(meth)acrylate, diethylene glycol di(meth)acrylate, triethylene glycol di(meth)acrylate, propylene glycol di(meth)acrylate, neopentyl glycol di(meth)acrylate, 1,4-butanediol di(meth)acrylate, 1,6-hexanediol di(meth)acrylate, bisphenolA di(meth)acrylate, pentaerythritol di(meth)acrylate, pentaerythritol tri(meth)acrylate, pentaerythritol tetra(meth)acrylate, pentaerythritol hexa(meth)acrylate, dipentaerythritol di(meth)acrylate, dipentaerythritol tri(meth)acrylate, dipentaerythritol penta(meth)acrylate, dipentaerythritol hexa(meth)acrylate, bisphenol A epoxy(meth)acrylate, ethylene glycol monomethylether (meth)acrylate, trimethylol propane tri(meth)acrylate, tris(meth)acryloyloxyethyl phosphate, novolacepoxy (meth)acrylate, and the like, and combinations thereof.

Commercially available examples of the photopolymerizable compound are as follows. The mono-functional (meth)acrylic acid ester may include without limitation Aronix M-101®, M-111®, M-114® (TOAGOSEI CHEMICAL INDUSTRY CO., LTD.); KAYARAD TC-110S®, TC-120S® (NIPPON KAYAKU CO., LTD.); V-158®, V-2311® (OSAKA ORGANIC CHEMICAL IND., LTD.), and the like. Examples of a difunctional (meth)acrylic acid ester may include without limitation Aronix M-210®, M-240®, M-6200® (TOAGOSEI CHEMICAL INDUSTRY CO., LTD.), KAYARAD HDDA®, HX-220®, R-604® (NIPPON KAYAKU CO., LTD.), V-260®, V-312®, V-335 HP® (OSAKA ORGANIC CHEMICAL IND., LTD.), and the like. Examples of a tri-functional (meth)acrylic acid ester may include without limitation Aronix M-309®, M-400®, M-405®, M-450®, M-7100®, M-8030®, M-8060® (TOAGOSEI CHEMICAL INDUSTRY CO., LTD.), KAYARAD TMPTA®, DPCA-20®, DPCA-30®, DPCA-60®, DPCA-120® (NIPPON KAYAKU CO., LTD.), V-295®, V-300®, V-360®, V-GPT®, V-3PA®, V-400® (Osaka Yuki Kayaku Kogyo Co. Ltd.), and the like. The commercially available products may be used singularly or as a mixture of two or more kinds.

The photopolymerizable compound may be treated with acid anhydride to improve developability.

The photosensitive resin composition may include the photopolymerizable compound in an amount ranging from about 1 to about 20 wt %, for example about 1 to about 5 wt %, based on the total weight (100 wt %) of the photosensitive resin composition. In some embodiments, the photosensitive resin composition may include the photopolymerizable compound in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of photopolymerizable compound can be in a range from about any of the foregoing amounts to about any other of the foregoing amounts.

When the photosensitive resin composition includes the photopolymerizable compound in an amount within the above range, curing at exposure during pattern forming processes can be sufficiently performed, and the photopolymerizable compound can have good sensitivity under oxygen, and compatibility with the binder resin.

(D) Photopolymerization Initiator

The photopolymerization initiator produces radicals at exposure and causes photopolymerization during a pattern-forming process in the photosensitive resin composition.

Examples of the photopolymerization initiator may include without limitation acetophenone-based compounds, benzophenone-based compounds, thioxanthone-based compounds, benzoin-based compounds, triazine-based compounds, oxime-based compounds, and the like, and combinations thereof.

Examples of the acetophenone-based compounds may include without limitation 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like, and combinations thereof.

Examples of the benzophenone-based compounds may include without limitation benzophenone, benzoyl benzoic acid, benzoyl benzoic acid methyl, 4-phenyl benzophenone, hydroxy benzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like, and combinations thereof.

Examples of the thioxanthone-based compounds may include without limitation thioxanthone, 2-crolthioxanthone, 2-methylthioxanthone, isopropyl thioxanthone, 2,4-diethyl thioxanthone, 2,4-diisopropyl thioxanthone, 2-chlorothioxanthone, and the like, and combinations thereof.

Examples of the benzoin-based compounds may include without limitation benzoin, benzoin methyl ether, benzoin ethyl ether, benzoin isopropyl ether, benzoin isobutyl ether, benzyldimethyl ketal, and the like, and combinations thereof.

Examples of the triazine-based compounds may include without limitation 2,4,6-trichloro-s-triazine, 2-phenyl 4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloro methyl)-s-triazine, 2-biphenyl 4,6-bis(trichloro methyl)-s-triazine, bis(trichloromethyl)-6-styryl-s-triazine, 2-(naphthol-yl)-4,6-bis(trichloromethyl)-s-triazine, 2-(4-methoxynaphthol-yl)-4,6-bis(trichloromethyl)-s-triazine, 2-4-bistrichloromethyl-6-piperonyl-s-triazine, 2-4-bis(trichloromethyl)-6-(4-methoxystyryl)-s-triazine, and the like, and combinations thereof.

Examples of the oxime-based compounds may include without limitation 2-(o-benzoyloxime)-1-[4-(phenylthio)phenyl]-1,2-octandione, 1-(o-acetyloxime)-1-[9-ethyl-6-(2-methylbenzoyl)-9H-carbazol-3-yl]ethanone, and the like, and combinations thereof.

The photopolymerization initiator may further include a carbazole-based compound, a diketone-based compound, a sulfonium borate-based compound, a diazo-based compound, an imidazole-based compound, and/or a biimidazole-based compound.

The photosensitive resin composition may include the photopolymerization initiator in an amount of about 0.05 to about 5.0 wt %, for example about 0.5 to about 2.0 wt %, based on the total weight (100 wt %) of the photosensitive resin composition. In some embodiments, the photosensitive resin composition may include the photopolymerization initiator in an amount of about 0.05, 0.06, 0.07, 0.08, 0.09, 0.1, 0.2, 0.3, 0.4, 0.5, 0.6, 0.7, 0.8, 0.9, 1, 2, 3, 4, or 5 wt %. Further, according to some embodiments of the present invention, the amount of photopolymerization initiator can be in a range from about any of the foregoing amounts to about any other of the foregoing amounts.

When the photosensitive resin composition includes the photopolymerization initiator in an amount within the above range, sufficient photopolymerization can be performed at exposure during pattern forming process, and decrease of transmittance due to non-reacting initiators may be minimized or eliminated.

(E) Inorganic Filler

The photosensitive resin composition includes the inorganic filler in an amount of about 0.05 to about 5 wt % based on the total weight (100 wt %) of the photosensitive resin composition. In some embodiments, the photosensitive resin composition may include the inorganic filler in an amount of about 0.05, 0.06, 0.07, 0.08, 0.09, 0.1, 0.2, 0.3, 0.4, 0.5, 0.6, 0.7, 0.8, 0.9, 1, 2, 3, 4, or 5 wt %. Further, according to some embodiments of the present invention, the amount of inorganic filler can be in a range from about any of the foregoing amounts to about any other of the foregoing amounts.

The photosensitive resin composition includes the inorganic filler along with the organic black pigment or organic mixed pigment. The photosensitive resin composition can have an O.D. (Otical Depth) above a predetermined range after being coated to a thickness of about 4 μm and being cured, a predetermined transmittance at 950 nm wavelength, and excellent heat resistance, chemical resistance and/or reliability.

Examples of the inorganic filler may include without limitation titania, zirconia, nickel oxide, alumina powder, silica, and the like, and combinations thereof. In exemplary embodiments, the inorganic filler can include any of various kinds of silica, for example, fumed silica, fused silica, particulate silica, and the like, and combinations thereof.

Silica can be prepared through a gaseous reaction or a liquid reaction and may be spherical, non-spherical, and the like without particular limitation but may not be cohesive and well dispersed. Thus, in exemplary embodiments, amorphous particulate silica synthesized in a vapor method or non-crystalline fumed silica may be used. In particular, the amorphous particulate silica and non-crystalline fumed silica can have a higher purity than general silica (SiO₂) and thus can be transparent and can have a low refractive index and small light-processing loss and also, high melting control capability since their surfaces have a hydrophobic treatment.

The silica may have an average primary particle diameter of about 1 to about 50 nm, for example about 5 to about 20 nm, and as another example about 7 to about 15 nm, without limitation.

(F) Solvent

Examples of the solvent may include without limitation alcohols such as methanol, ethanol, and the like; ethers such as dichloroethyl ether, n-butyl ether, diisoamyl ether, methylphenyl ether, tetrahydrofuran, and the like; glycol ethers such as ethylene glycol methylether, ethylene glycol dimethylether, ethylene glycol ethylether, propylene glycol monomethylether, and the like; cellosolve acetates such as methyl cellosolve acetate, ethyl cellosolve acetate, diethyl cellosolve acetate, and the like; carbitols such as methylethyl carbitol, diethyl carbitol, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol methylether acetate, propylene glycol propylether acetate, and the like; aromatic hydrocarbons such as toluene, xylene, and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; lactate alkyl esters such as methyl lactate, ethyl lactate, and the like; alkyl hydroxy acetate esters such as methyl hydroxyacetate, ethyl hydroxyacetate, butyl hydroxyacetate, and the like; alkoxyalkyl acetate esters such as methoxymethyl acetate, methoxyethyl acetate, methoxybutyl acetate, ethoxymethyl acetate, ethoxyethyl acetate, and the like; alkyl 3-hydroxypropionate esters such as methyl 3-hydroxypropionate, ethyl 3-hydroxypropionate, and the like; alkyl 3-alkoxypropionate esters such as methyl 3-methoxypropionate, ethyl 3-methoxypropionate, ethyl 3-ethoxypropionate, methyl 3-ethoxypropionate, and the like; alkyl 2-hydroxypropionate esters such as methyl 2-hydroxypropionate, ethyl 2-hydroxypropionate, propyl 2-hydroxypropionate, and the like; alkyl 2-alkoxypropionate esters such as methyl 2-methoxypropionate, ethyl 2-methoxypropionate, ethyl 2-ethoxypropionate, methyl 2-ethoxypropionate, and the like; alkyl 2-hydroxy-2-methylpropionate esters such as methyl 2-hydroxy-2-methylpropionate, ethyl 2-hydroxy-2-methylpropionate, and the like; alkyl 2-alkoxy-2-methylpropionate esters such as methyl 2-methoxy-2-methylpropionate, ethyl 2-ethoxy-2-methylpropionate, and the like; esters such as 2-hydroxyethyl propionate, 2-hydroxy-2-methylethyl propionate, hydroxyethyl acetate, methyl 2-hydroxy-3-methylbutanoate, and the like; ketonate esters such as ethyl pyruvate, and the like, and combinations thereof. Additionally, the following solvents may be also used: N-methylformamide, N,N-dimethyl formamide, N-methylformanilide, N-methylacetamide, N,N-dimethyl acetamide, N-methylpyrrolidone, dimethylsulfoxide, benzylethylether, dihexylether, acetylacetone, isophorone, caproic acid, caprylic acid, 1-octanol, 1-nonanol, benzylalcohol, benzyl acetate, ethyl benzoate, diethyl oxalate, diethyl maleate, γ-butyrolactone, ethylene carbonate, propylene carbonate, phenyl cellosolve acetate, and the like. These solvents may be used singularly or as a mixture of two or more.

Considering miscibility and reactivity, glycol ethers such as ethylene glycol monoethylether, ethylene glycol dimethylether, and the like; ethylene glycol alkylether acetates such as ethyl cellosolve acetate, and the like; esters such as 2-hydroxy ethyl propionate, and the like; diethylene glycol alkylethers such as diethylene glycol monomethylether, and the like; propylene glycol alkylether acetates such as propylene glycol monomethylether acetate, propylene glycol propylether acetate, and the like, and combinations thereof may be used.

The photosensitive resin composition may include the solvent in a balance amount, for example about 50 to about 90 wt %, and as another example about 70 to about 85 wt %, based on the total weight (100 wt %) of the photosensitive resin composition. In some embodiments, the photosensitive resin composition may include the solvent in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of solvent can be in a range from about any of the foregoing amounts to about any other of the foregoing amounts.

When the photosensitive resin composition includes the solvent in an amount within the above range, the photosensitive resin composition may have an appropriate viscosity which can result in improved processibility.

(G) Other Additive(s)

The photosensitive resin composition may further include one or more other additives. Examples of the other additives can include without limitation malonic acid; 3-amino-1,2-propanediol; silane-based coupling agents including a vinyl group or a (meth)acryloxy group; leveling agents; fluorine-based surfactants; radical polymerization initiators, and the like, and combinations thereof, in order to prevent stains and/or spots during the coating, to adjust leveling, and/or to prevent pattern residue due to non-development.

Examples of the silane-based coupling agent may include without limitation trimethoxysilyl benzoic acid, γ-methacryl oxypropyl trimethoxysilane, vinyl triacetoxysilane, vinyl trimethoxysilane, γ-iso cyanate propyl triethoxysilane, γ-glycidoxy propyl trimethoxysilane, β-(3,4-epoxycyclohexyl)ethyltrimethoxysilane, and the like. They may be used singularly or as a mixture of two or more.

Examples of the fluorine-based surfactant may include without limitation commercial products, for example BM-1000®, and BM-1100® (BM Chemie Inc.); MEGAFACE F 142D®, F 172®, F 173®, and F 183® (DAINIPPON INK KAGAKU KOGYO CO., LTD.); FULORAD FC-135®, FULORAD FC-170C®, FULORAD FC-430®, and FULORAD FC-431® (SUMITOMO 3M CO., LTD.); SURFLON S-112®, SURFLON S-113®, SURFLON S-131®, SURFLON S-141®, and SURFLON S-145® (ASAHI GLASS CO., LTD.); and SH-28PA®, SH-190®, SH-193®, SZ-6032®, and SF-8428®, and the like (TORAY SILICONE CO., LTD.), and combinations thereof.

The amount of the additive(s) may be easily adjusted depending on desired properties.

According to another embodiment, a black spacer manufactured using the photosensitive resin composition is provided. The black spacer has a structure of combining a light-blocking layer and a column spacer and may be obtained through one pattern-forming process.

The black spacer may be manufactured as follows. (1) Coating and Film Formation

The photosensitive resin composition can be coated to have a desired thickness, for example, a thickness ranging from about 2 to about 25 μm, on a substrate which undergoes a predetermined pretreatment, using a spin or slit coating method, a roll coating method, a screen-printing method, an applicator method, and the like. Then, the coated substrate can be primarily heated (also referred to be as “pre-bake”) at a temperature ranging from about 70 to about 100° C. for about 1 to about 10 minutes to remove a solvent.

(2) Exposure

The film can be radiated by an active ray ranging from 200 to 500 nm after putting a mask having a half tone for realizing a light-blocking layer pattern and a full tone for realizing a column spacer pattern. The radiation can be performed by using a light source such as a mercury lamp with a low pressure, a high pressure, or an ultrahigh pressure, a metal halide lamp, an argon gas laser, and the like. An X ray, an electron beam, and the like may be also used. The light dose may vary depending on kinds of each component of the photosensitive resin composition, its combination ratio, and a dry film thickness. For example, a light dose may be about 500 mJ/cm² or less (with 365 nm sensor) when a high pressure mercury lamp is used.

(3) Development

After the exposure process, an alkali aqueous solution can be used to develop the exposed film by dissolving and removing an unnecessary part except the exposed part, forming a pattern. The obtained pattern can have a film step difference between the light-blocking layer and column spacer patterns.

(4) Post-Treatment

The image pattern obtained by the development may be secondarily heated (also referred to be as “post-bake”) at about 200 to about 250° C. for about 15 to about 40 minutes in order to obtain a pattern that can have excellent heat resistance, light resistance, close contacting properties, crack resistance, chemical resistance, high strength, and/or storage stability.

Hereinafter, the present invention is illustrated in more detail with reference to the following examples. These examples, however, are not in any sense to be interpreted as limiting the scope of the invention.

### (Preparation of Photosensitive Resin Composition)

Each component used in preparation of a photosensitive resin composition is as follows.

(A) Colorant

(A-1) A mill base (Mikuni Co.) including OBP (lactam-based organic black) made by BASF Co. is used.

(A-2) A mill base (Tokushiki Co. Ltd.) including carbon black is used.

(B) Binder Resin

(B-1) KBR101 made by Kyung-ln Synthetic Co. is used as a cardo-based resin.

(B-2) BX-04 made by Japan Catalyst Company is used as an acrylic-based resin.

(C) Photopolymerizable Compound

Dipentaerythritolhexaacrylate is used.

(D) Photopolymerization Initiator

OXE01 made by BASF Co. is used.

(E) Inorganic Filler

Fumed silica made by Evonik Industries is used.

(F) Solvent

(F-1) Propylene glycol monomethylether acetate (PGMEA) is used.

(F-2) Ethylene glycol dimethylether (EDM) is used.

(G) Additive

γ-glycidoxy propyl trimethoxysilane (S-510, Chisso Co.) as a silane coupling agent is used.

### Example 1 and Comparative Examples 1 to 3

### Preparation of Photosensitive Resin Compositions

Each component according to the compositions in the following Table 1 is mixed to prepare a photosensitive resin composition. Specifically, a photopolymerization initiator is dissolved in a solvent, and the solution is sufficiently agitated for about 30 minutes at room temperature. A binder resin and a photopolymerizable compound are added thereto, and the mixture is agitated for one hour. An additive is added thereto, a colorant is added thereto, and the mixture is agitated for about 2 hours. The solution is 3 times filtered to remove impurities, preparing the photosensitive resin composition.

TABLE 1

| | | Example | Comparative Example | | |
|---|---|---|---|---|---|
| (wt %) | | 1 | 1 | 2 | 3 |
| (D) photopolymerization | | 0.464 | 0.527 | 0.379 | 0.379 |
| initiator | | | | | |
| (B) binder resin | B-1 | 4.82 | 5.472 | 3.935 | 3.935 |
| | B-2 | 4.82 | 5.472 | 3.935 | 3.935 |
| (C) photopolymerizable | | 2.566 | 2.913 | 2.095 | 2.095 |
| compound | | | | | |
| (A) colorant | A-1 | 6.397 | 6.397 | 10.737 | 6.397 |
| | A-2 | 1.438 | 1.438 | 1.438 | 5.778 |
| (E) inorganic filler | | 1.840 | — | — | — |
| (F) solvent | F-1 | 61.371 | 61.371 | 61.371 | 61.371 |
| | F-2 | 15.343 | 15.343 | 15.343 | 15.343 |

| | | | | |
|---|---|---|---|---|
| (G) additive | 0.941 | 1.068 | 0.768 | 0.768 |

### Evaluation 1: Measurement and Evaluation of Optical Depth and Transmittance

Each photosensitive resin composition according to Example 1 and Comparative Examples 1 to 3 are respectively spin-coated to be less than or equal to 5 μm thick on a glass substrate, primarily pre-baked at 90° C. for 1 minute to remove the solvent, forming each film. Subsequently, each film is exposed to an active ray ranging from 300 to 450 nm with an exposure dose of 120 mJ/cm² by using a mercury light source. The formed patterns are secondarily post-heated at 220° C. for 20 minutes to respectively form uniformly-thick (4 μm) black spacer films, and transmittance at 950 nm and O.D. (Optical Depth) of the films are determined.

The O.D. is measured in a method of measuring illumination of light transmitting the black spacer films with a spectrophotometer. The transmittance at 950 nm is measured by measuring transmission of light at the corresponding wavelength with UV/Vis spectroscopy.

TABLE 2

| | Example | Comparative Examples | | |
|---|---|---|---|---|
| | 1 | 1 | 2 | 3 |
| O.D. | 3.02 | 3.05 | 3.89 | 4.94 |
| Transmittance | 21.3% | 21.5% | 20.1% | 2.3% |

Based on the results, the photosensitive resin compositions of Example 1 and Comparative Examples 1 and 2 including an organic black pigment exhibit O.D. and transmittance at 950 nm required of a black spacer film coated to be 4 μm thick. In contrast, the photosensitive resin composition of Comparative Example 3 including greater than 50 wt % of carbon black relative to the amount of an organic black pigment exhibits high O.D. but not desired transmittance.

Evaluation 2: Film Residual Rate of Black Spacer after Post-Baking

Thickness of the black spacer patterns before and after post-baking is measured by using a 3-D profiler, and the results are provided in the following Table 3.

A film residual rate (%) in the following Table 3 is calculated as a percentage of thickness after the post-baking relative to thickness before the post-baking.

TABLE 3

| | Total black spacer pattern | | | Part of light-blocking layer pattern | | | Part of column spacer pattern | | |
|---|---|---|---|---|---|---|---|---|---|
| | Film | Film | | Film | Film | | Film | Film | |
| | thickness | thickness | Film | thickness | thickness | Film | thickness | thickness | Film |
| | before | after | residual | before | after | residual | before | after | residual |
| | post-bake | post-bake | rate | post-bake | post-bake | rate | post-bake | post-bake | rate |
| | (μm) | (μm) | (%) | (μm) | (μm) | (%) | (μm) | (μm) | (%) |
| Ex. 1 | 3.89 | 3.05 | 78.5 | 1.93 | 1.47 | 76.2 | 1.97 | 1.59 | 80.8 |
| Comp. Ex. 1 | 3.63 | 1.70 | 46.8 | 1.96 | 1.64 | 83.4 | 1.67 | 0.06 | 3.8 |
| Comp. Ex. 2 | 3.96 | 3.02 | 76.1 | 1.90 | 1.45 | 76.6 | 2.07 | 1.56 | 75.6 |
| Comp. Ex. 3 | 3.83 | 3.07 | 80.1 | 1.92 | 1.60 | 83.1 | 1.91 | 1.47 | 77.1 |

Referring to Table 3, Example 1 using an organic black pigment and an inorganic filler exhibits a high film residual rate and a desired step difference, as compared with Comparative Example 1 using the same amount of a pigment but no inorganic filler. In addition, Comparative Examples 2 and 3 including a greater amount of a pigment than Example 1 exhibit some step differences.

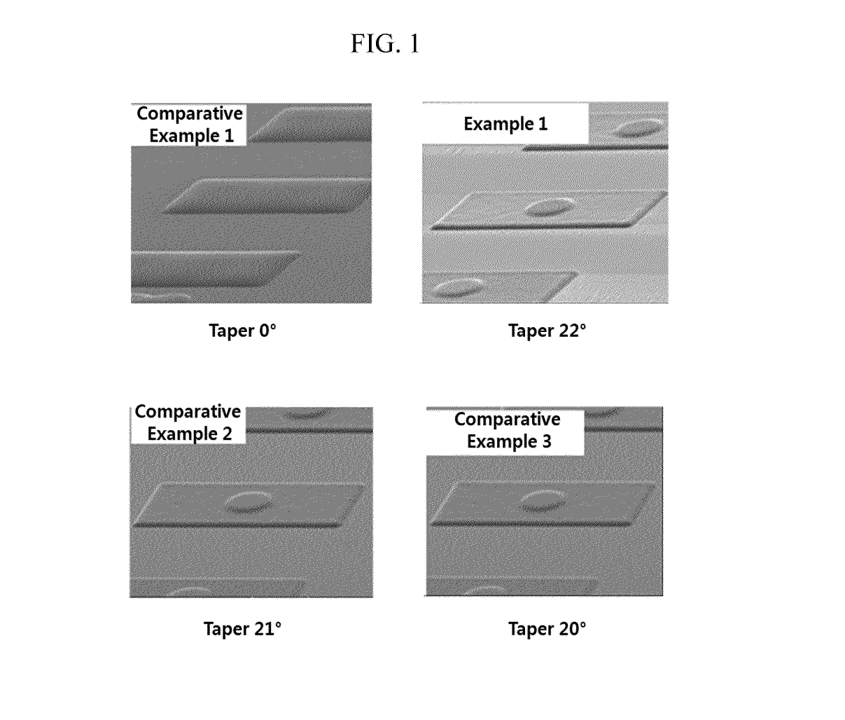

In addition, FIG. 1 includes scanning electron microscope (SEM) photographs of Example 1 and Comparative Examples 1-3 showing tapering measurements after the post-baking. Referring to FIG. 1, Example 1 (taper) 22° and Comparative Examples 2 (taper 21°) and 3 (taper 20°) exhibit a large tapering and a clear step difference. In contrast, Comparative Example 1 using the same amount of a colorant (about 21%) but no inorganic filler exhibits 0° tapering and realized no step difference at all.

### Evaluation 3: Elution of Black Spacer

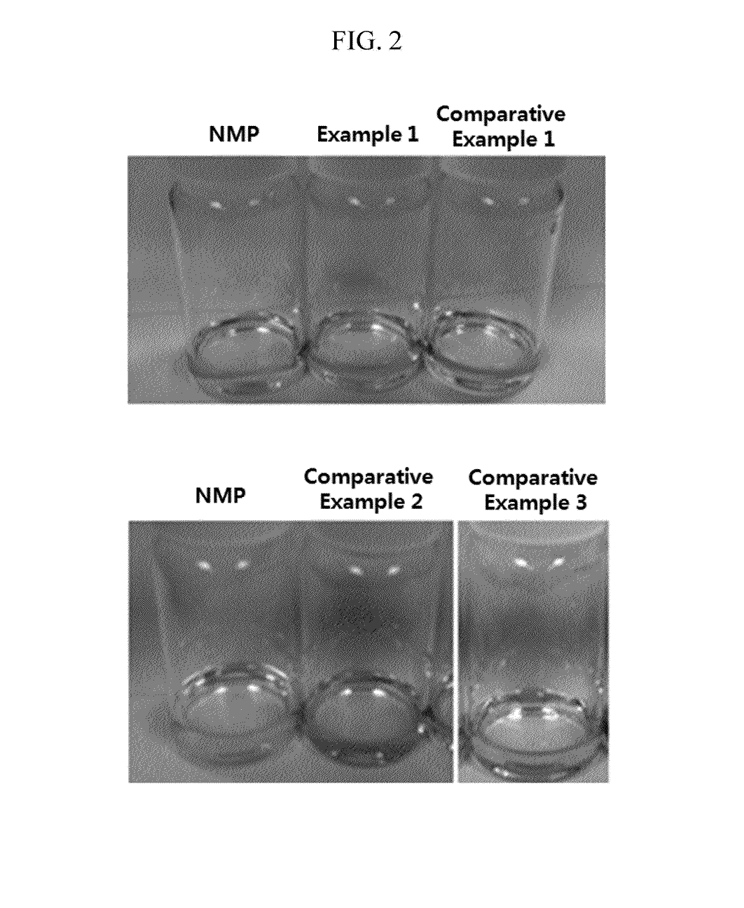

The pattern of the black spacers is cut into 16 films having a size of 1 cm×1 cm, put in a glass bottle containing 5 mL of N-methylpyrrolidone, and then, allowed to stand in a 100° C. oven for 15 minutes to examine if the films are color-eluted or not. The eluted color might be different depending on the pigment used but is compared with the color of the pure N-methylpyrrolidone, and the results are provided in FIG. 2.

FIG. 2 includes photographs showing elution evaluation results of the black spacers of Example 1 and Comparative Examples 1 to 3.

Referring to FIG. 2, Example 1 using a colorant including an organic black pigment and an inorganic pigment along with an inorganic filler exhibits excellent solvent resistance compared with Comparative Example 2 using the colorant but no inorganic filler. In other words, Example 1 maintains the color of the NMP solvent itself and exhibits almost no color elution. Comparative Example 1 using the same amount of the colorant as that of Example 1 did not exhibit much color elution. However, Comparative Example 1 did not realize a step difference after the post-baking and thus, is not used as a black spacer as shown in the result of Evaluation 2. In contrast, Comparative Example 2 exhibits relatively high tapering as shown in the result of Evaluation 2 but high elution of a black pigment as shown in FIG. 2. In other words, when a colorant such as an organic black pigment and the like is used in a higher amount to increase tapering, the tapering is increased but heat resistance, chemical resistance, and/or reliability are not sufficient for a black spacer. Comparative Example 3 exhibits a step difference, high tapering, and good elution in NMP but did not reach 10% of transmittance at a thickness of 4 μm in a wavelength region of about 950 nm near to IR (infrared ray), which is requirement of a black spacer.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A photosensitive resin composition, comprising
(A) a colorant including an organic black pigment or an organic mixed pigment capable of showing black;
(B) a binder resin;
(C) a photopolymerizable compound;
(D) a photopolymerization initiator;
(E) an inorganic filler; and
(F) a solvent,
wherein the composition has an O.D. of greater than or equal to about 2.0 after being coated on a substrate to a thickness of about 4 μm and being cured, and transmittance of greater than or equal to about 12% in a 950 nm wavelength region.

2. The photosensitive resin composition of claim 1, wherein the organic black pigment is represented by the following Chemical Formula 1: 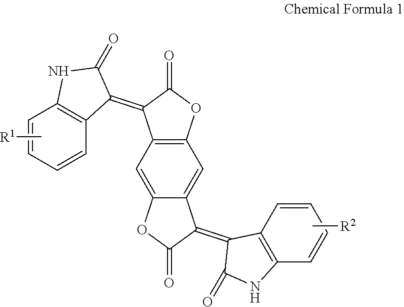
wherein in Chemical Formula 1, R¹ and R² are the same or different and are each independently hydrogen, halogen, or substituted or unsubstituted C1 to C20 alkyl.

3. The photosensitive resin composition of claim 1, wherein the colorant further comprises an inorganic black pigment.

4. The photosensitive resin composition of claim 3, comprising the inorganic black pigment in an amount of about 10 to about 50 wt % based on the total weight of the organic black pigment or organic mixed pigment capable of showing black.

5. The photosensitive resin composition of claim 1, comprising the organic black pigment or organic mixed pigment capable of showing black in an amount of about 1 to about 20 wt % based on the total weight of the photosensitive resin composition.

6. The photosensitive resin composition of claim 1, wherein the binder resin (B) is a cardo-based resin or a mixture of a cardo-based resin and an acrylic-based resin.

7. The photosensitive resin composition of claim 1, wherein the inorganic filler (E) is silica.

8. The photosensitive resin composition of claim 1, comprising the inorganic filler (E) in an amount of about 0.05 to about 5 wt % based on the total weight of the photosensitive resin composition.

9. The photosensitive resin composition of claim 1, wherein the photosensitive resin composition comprises:
about 1 to about 20 wt % of (A) the colorant including an organic black pigment or an organic mixed pigment capable of showing black;
about 2 to about 20 wt % (B) the binder resin;
about 1 to about 20 wt % of (C) the photopolymerizable compound;
about 0.05 to about 5.0 wt % of (D) the photopolymerization initiator;
about 0.05 to about 5 wt % of (E) the inorganic filler; and
a balance amount of (F) the solvent.

10. A black spacer manufactured using the photosensitive resin composition of claim 1.

11. A color filter comprising the black spacer according to claim 10.
